(19) United States
(12) Patent Application Publication
(10) Pub. No.: US 2009/0017690 A1
(43) Pub. Date: Jan. 15, 2009

(54) Electrical connector assembly and male type connector

(76) Inventor: Yoshifumi Suemitsu, Tokyo (JP)

Correspondence Address: BARLEY SNYDER, LLC, 1000 WESTLAKES DRIVE, SUITE 275, BERWYN, PA, 19312, US

(21) Appl. No.: 12/171,493

(22) Filed: Jul. 11, 2008

(30) Foreign Application Priority Data
Jul. 13, 2007 (JP) 2007-184179

(51) Int. Cl. H01R 9/03

(52) U.S. Cl. 439/656

(57) ABSTRACT

An electrical connector assembly includes a male connector including a male housing and a retainer. The male housing is provided with a plurality of contact insertion openings and a retainer receiving slot. The retainer is provided with contact receiving slots corresponding to the contact insertion openings. The retainer is received in the retainer receiving slot in a direction perpendicular to a direction of extension of the contact insertion openings. The retainer is moveable between a pre-latched state where the contact insertion openings are misaligned from the contact receiving slots and a latched state where the contact insertion openings are aligned with the contact receiving slots.

### CROSS-REFERENCE TO RELATED APPLICATIONS

This application claims the benefit of the filing date under 35 U.S.C. §119(a)-(d) of Japan Patent Application No. 2007-184179, filed Jul. 13, 2007.

### FIELD OF THE INVENTION

The present invention relates to an electrical connector assembly comprising a female connector having a female housing and a male connector that mates with the female connector and has a male housing accommodated in the female housing.

### BACKGROUND

Conventionally, an electrical connector assembly comprising a female connector and a male connector that mates with the female connector has been used to electrically connect a circuit board in an electronic device for a vehicle to electric wires. The female connector generally includes a female housing and a plurality of male contacts that are installed in the female housing and are connected to the circuit board. On the other hand, the male connector generally includes a male housing accommodated in the female housing. Female contacts installed in the male housing are connected to the electric wires and come into contact with the male contacts.

In recent years, it has been required that such an electrical connector assembly used to electrically connect such a circuit board in an electronic device for a vehicle to electric wires be downsized. To prevent the female contacts from coming off the male connector, a lance is provided in the male connector housing or the female contact. To meet the requirement for downsizing the electrical connector assembly, the male connector must naturally be downsized. To downsize the male connector, the density of internal structure thereof is increased, so that the female contact is downsized. As a result, the size of the lance is also decreased. If the size of the lance is decreased, a force capable of holding the female contact decreases, so that the function of preventing the female contacts from coming off also decreases. Also, if the size of the lance is decreased, there arises a problem in that it is difficult to mold the lance by using molding dies.

Thereupon, the applicant of the present invention has already proposed an electrical connector assembly having a configuration in which a male connector 5 includes a lance block 3 for pre-latching a female contact 1 in a male housing 2 and a retainer 4 for latching the female contact 1, which has been pre-latched by the lance block 3, to the male housing 2, as shown in FIG. 9 (Japanese Patent Application No. 2006-155018). In the proposed electrical connector assembly, in order to install the female contact 1 in the male housing 2, the lance block 3 is first installed in the male housing 2. The female contact 1 is then inserted into a contact slot 6 formed in the male housing 2. In this state, the female contact 1 in the contact slot 6 is pre-latched by the lance block 3. Thereafter, the retainer 4 is installed in the male housing 2, and the female contact 1 is latched. Thus, the female contact 1 is latched to the male housing 2 by the lance block 3 and the retainer 4 in a state of being inserted into the contact slot 6.

In the electrical connector assembly, although it goes without saying that the downsizing is needed, it is essential that the electrical conduction between the male contact and the female contact be established reliably. From the viewpoint of reliable electrical conduction between the male contact and the female contact, it has been found by the inventors that the electrical connector assembly shown in FIG. 9, in which the female contact 1 is fixed to the male housing 2 by the lance block 3 and the retainer 4, has several drawbacks. First, when the male connector 5 to which the female contact 1 has been installed is inserted into and engaged with a female connector 7, the lance block 3 and the retainer 4 are not pushed completely into the male housing 2 in some cases. In such a case, the lance block 3 and the retainer 4 project from the male housing 2, so that usually, the male connector 5 cannot be inserted into the female connector 7.

However, the fact that the lance block 3 and the retainer 4 have not been pushed in completely becomes clear when the male connector 5 is inserted into the female connector 7 and the lance block 3 and the retainer 4 which project from the male housing 2 come into contact with a female housing 8 of the female connector 7. In the case where the fact that the lance block 3 and the retainer 4 have not been pushed in completely becomes clear, the male connector 5 is pulled out of the female connector 7. After the lance block 3 and the retainer 4 have been pushed in and engaged with the male housing 2 reliably, the male connector 5 is again inserted into the female connector 7. This procedure decreases the work efficiency.

Also, even if the lance block 3 and the retainer 4 have not been pushed in completely and project from the male housing 2, the male connector 5 can sometimes be inserted into the female connector 7 if the lance block 3 and the retainer 4 are pushed in forcedly because the female housing 8 of the female connector 7 is made of a resin and therefore has elasticity. In this case, the female contact 1 is not fixed in the male housing 2 reliably, so that the engagement of the female contact 1 with a male contact 9 on the female connector 7 side may be incomplete. Furthermore, since the male connector 5 is formed by the three parts, that is, the male housing 2, the lance block 3, and the retainer 4, the assembling manpower increases.

As described above, the prior art still has room for improvement in terms of the increase in work efficiency and the increase in the reliability due to complete engagement of the male contact with the female contact.

### SUMMARY

It is therefore an object of the present invention to provide an electrical connector assembly in which a male contact is reliably engaged with a female contact to increase the reliability and work efficiency and to provide a male connector used in such an electrical connector assembly.

This and other objects are achieved by an electrical connector assembly comprising a male connector including a male housing and a retainer. The male housing is provided with a plurality of contact insertion openings and a retainer receiving slot. The retainer is provided with contact receiving slots corresponding to the contact insertion openings. The retainer is received in the retainer receiving slot in a direction perpendicular to a direction of extension of the contact insertion openings. The retainer is moveable between a pre-latched state where the contact insertion openings are misaligned from the contact receiving slots and a latched state where the contact insertion openings are aligned with the contact receiving slots.

### BRIEF DESCRIPTION OF THE DRAWINGS

FIG. 1 is a perspective view of an electrical connector assembly in accordance with one embodiment of the present invention showing a state in which a male connector is about to mate with a female connector in a state in which a retainer projects from the male connector;

FIG. 2A is a cross-sectional view of a male connector about to mate with a female connector with the retainer in a pre-latched state;

FIG. 2B is an enlarged cross-sectional view of a portion of FIG. 2A showing a positional relationship between a contact insertion opening of a male housing and a female contact when the retainer is in the pre-latched state;

FIG. 3 is a perspective view of the male housing and the retainer;

FIG. 4 is a cross-sectional view of a positional relationship between a convex locking member of the retainer and first and second locking claws of the male housing;

FIG. 5A is a perspective view of the pre-latched state in which the retainer projects from the male connector;

FIG. 5B is a front view of the pre-latched state in which the retainer projects from the male connector;

FIG. 6A is a perspective view of a latched state in which the retainer does not project from the male connector;

FIG. 6B is a cross-sectional view of the latched state in which the retainer does not project from the male connector;

FIG. 7A is a cross-sectional view of a positional relationship between a lock claw and a locking claw at a time when the retainer is in the pre-latched state;

FIG. 7B is a cross-sectional view of a positional relationship between the lock claw and the locking claw at the time when the retainer is in the latched state;

FIG. 8A is a cross-sectional view of the male connector mated with the female connector when the retainer is in the latched state;

FIG. 8B is an enlarged cross-sectional view of a portion of FIG. 8A showing a positional relationship between the male contact and the female contact at the time when the retainer is in the latched state; and

FIG. 9 is a cross-sectional view of a contact according to the prior art.

### DETAILED DESCRIPTION OF THE EMBODIMENT(S)

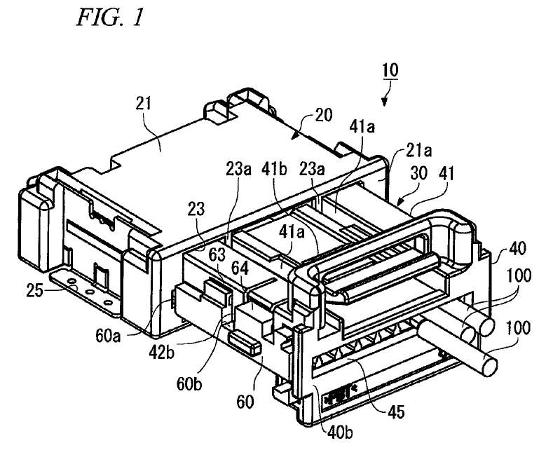

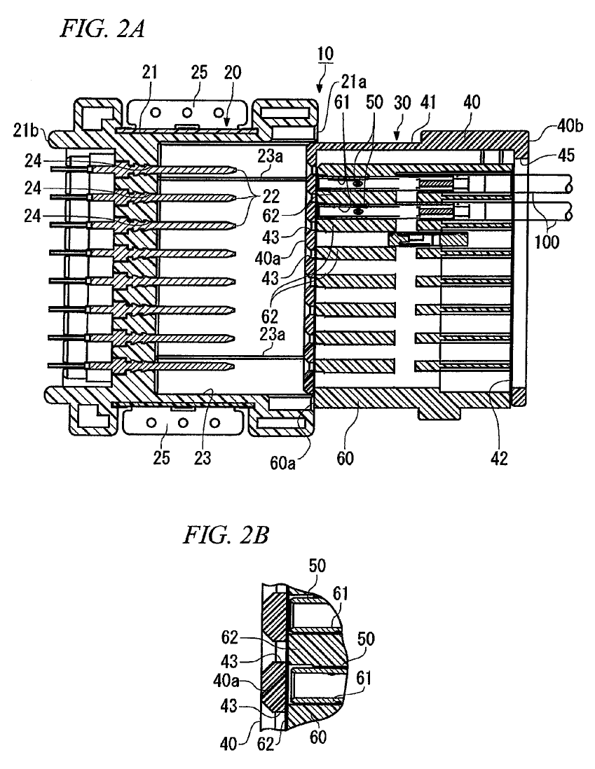

The present invention will now be described in detail based on an embodiment shown in the accompanying drawings. As shown in FIGS. 1-2B, an electrical connector assembly 10 comprises a female connector 20 and a male connector 30. The female connector 20 includes a female housing 21 formed of an insulative resin. A plurality of male contacts 22 are provided in the female housing 21. As shown in FIG. 2A, the female housing 21 is formed with a mating recess 23 for accommodating a male housing 40 in a side surface 21 a thereof. On an inner peripheral surface of the mating recess 23, ridges 23a extending in an insertion/removal direction of the male housing 40 are formed. The female housing 21 is provided with a plurality of contact receiving slots 24 extending through a side surface 21b of the female housing 21 to the mating recess 23. The contact receiving slots 24 are formed at a predetermined interval. The male contacts 22 are fitted in the contact receiving slots 24. On an outer peripheral surface of the female housing 21, a peg 25 for fixing the female housing 21 to a printed wiring board (not shown) is provided.

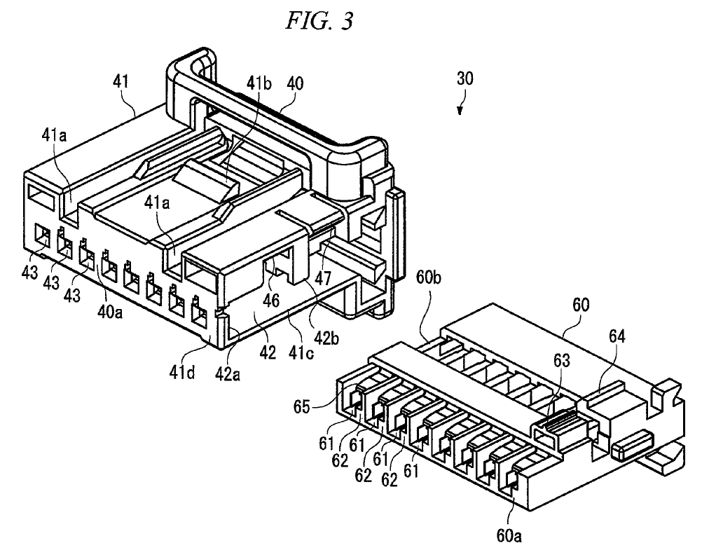

The male connector 30 includes the male housing 40 that is formed of an insulative resin. The male connector 30 is inserted into the mating recess 23 formed in the female housing 21. The male housing 40 includes a plurality of female contacts 50 capable of being electrically connected to the male contacts 22 and a retainer 60 for securing the female contacts 50 to the female housing 21. As shown in FIGS. 2A-3, the male housing 40 has a convex part 41 having a cross-sectional shape corresponding to the cross-sectional shape of the mating recess 23 of the female housing 21. On an outer peripheral surface of the convex part 41, guide grooves 41 a that are continuous in the insertion/removal direction of the male housing 40 with respect to the mating recess 23 are formed. The guide grooves 41a engage with the ridges 23a in the mating recess 23, by which the male housing 40 is guided in the insertion/removal direction of the male housing 40 with respect to the mating recess 23. The guide grooves 41a and the ridges 23a function as a key for preventing wrong engagement so that the male housing 40 and the female housing 21 are engaged with each other in a correct combination.

On an outer peripheral surface of the convex part 41, a locking claw 41b that engages with a locking recess (not shown) formed in the inner peripheral surface of the mating recess 23 is provided. The convex part 41 is inserted into the mating recess 23, and the locking claw 41b is locked to the locking concave part in the mating recess 23, by which the female housing 21 and the male housing 40 that have been engaged with each other are locked. In the male housing 40, a retainer receiving slot (slot) 42 extending in the direction perpendicular to the insertion/removal direction of the male housing 40 with respect to the female housing 21 is formed. The retainer receiving slot 42 is formed so as to be open to a side surface 41c of the convex part 41. An end part 42a of the retainer receiving slot 42 is located in the vicinity of a tip end part 41d of the convex part 41. On the inner peripheral surface of the retainer receiving slot 42, a ridge 42b extending in the same direction as that of the retainer receiving slot 42 is formed.

In the tip end surface 40a of the male housing 40, a plurality of contact insertion openings 43 in which the male contacts 22 are inserted are formed at the same interval as that of the male contacts 22 held in the female housing 21 of the female connector 20. In the male housing 40, an opening 45 penetrating from the other surface 40b to the retainer receiving slot 42 is formed. In the opening 45, electric wires 100 to be connected to the female contacts 50 are inserted. The opening 45 is formed into a slit shape extending in the slide direction of the retainer 60 so that the retainer 60 can be slid in the state in which the female contacts 50 connected to the tip end parts of the electric wires 100 are held by the retainer 60.

As shown in FIG. 3, the retainer 60 has a cross-sectional shape corresponding to the cross-sectional shape of the retainer receiving slot 42 in the male housing 40 so as to be capable of being inserted into the retainer receiving slot 42. In the retainer 60, a plurality of contact receiving slots 61 for holding the female contacts 50 are formed at a predetermined interval. In each of the contact receiving slots 61, a lance 65 that locks the female contact 50 is formed, so that in the contact slot 61, the tip end part of the female contact 50 is held so as to be located in almost the same plane as a side surface 60a of the retainer 60. The contact receiving slots 61 are partitioned from each other by partitions 62. Each of the partitions 62 is formed so as to have a cross section capable of closing the contact insertion opening 43 on the side surface 60a of the retainer 60. For the contact slot 61 formed in the retainer 60, a part 60b facing toward the ridge 42b of the retainer receiving slot 42 is open. When the retainer 60 is inserted into the retainer receiving slot 42, the ridge 42b engages with the part 60b, and locks the female contacts 50 held by the contact receiving slots 61.

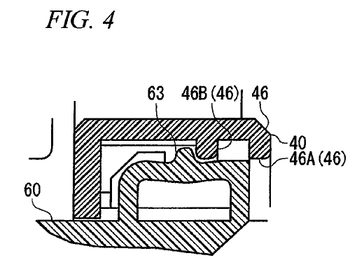

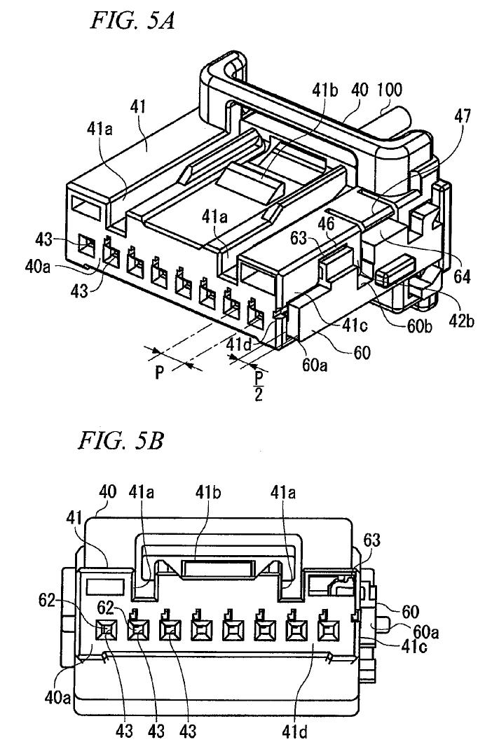

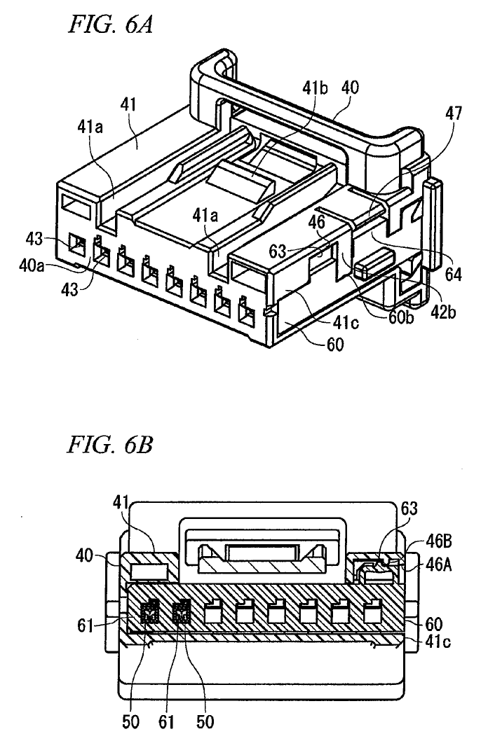

On the outer peripheral surface of the retainer 60, a convex locking member 63 for locking the retainer 60 having been inserted into the retainer receiving slot 42 and a lock claw 64 for preventing the retainer 60 from coming off the retainer receiving slot 42 are provided. On the other hand, on the inner peripheral surface of the retainer receiving slot 42, locking claws 46, 47 are formed at positions corresponding to the convex locking member 63 and the lock claw 64, respectively. As shown in FIG. 4, as the locking claw 46 engages with the convex locking member 63, a first locking claw 46A and a second locking claw 46B are provided at two locations spaced along the insertion/removal direction of the retainer 60 with respect to the retainer receiving slot 42. The first locking claw 46A is formed at a position at which the retainer 60 projects from the side surface 41 c of the convex part 41 of the male housing 40, as shown in FIG. 5 (a second position), in a state of being engaged with the convex locking member 63 of the retainer 60 inserted into the retainer receiving slot 42 (this state is referred to as a pre-latched state). The first locking claw 46A is formed so that the projection dimension from the side surface 41c of the retainer 60 is ½ of an arrangement pitch p of the adjacent contact receiving slots 61 (hereinafter, this dimension is referred to as a half pitch). As shown in FIGS. 6A-6B, the second locking claw 46B is formed at a position at which the retainer 60 does not project from the side surface 41c of the convex part 41 of the male housing 40 (a first position) in a state of being engaged with the convex locking member 63 of the retainer 60 inserted into the retainer receiving slot 42 (this state is referred to as a latched state).

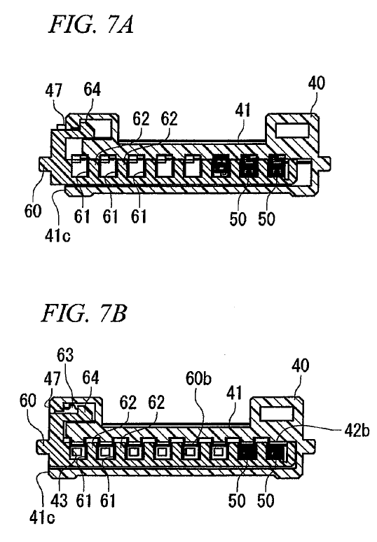

The locking claw 47 is formed at a position at which it engages with the lock claw 64 in the pre-latched state in which the first locking claw 46A engages with the convex locking member 63. At this time, as shown in FIGS. 7A-7B, the locking claw 47 and the lock claw 64 are formed so as to engage with each other more deeply than the engagement state of the first locking claw 46A with the convex locking member 63. The reason for this is that the retainer 60 that is in the pre-latched state in which the first locking claw 46A engages with the convex locking member 63 is prevented from coming off the retainer receiving slot 42. FIG. 7A is a cross-section showing a positional relationship between the lock claw 64 and the locking claw 47 in the pre-latched state, and FIG. 7B is a cross-section showing a positional relationship between the lock claw 64 and the locking claw 47 in the latched state.

To assemble the male connector 30 configured as described above, first, as shown in FIGS. 2A and 5A, the retainer 60 is inserted into the retainer receiving slot 42, and the first locking claw 46A is engaged with the convex locking member 63, by which the pre-latched state is formed. In this state, the retainer 60 projects by the half pitch from the side surface 41c of the convex part 41 of the male housing 40. As shown in FIGS. 2A-2B, the contact receiving slots 61 in the retainer 60 and the contact insertion openings 43 in the male housing 40 are misaligned with each other by the half pitch, and the partitions 62 are located at the positions facing to the contact insertion openings 43.

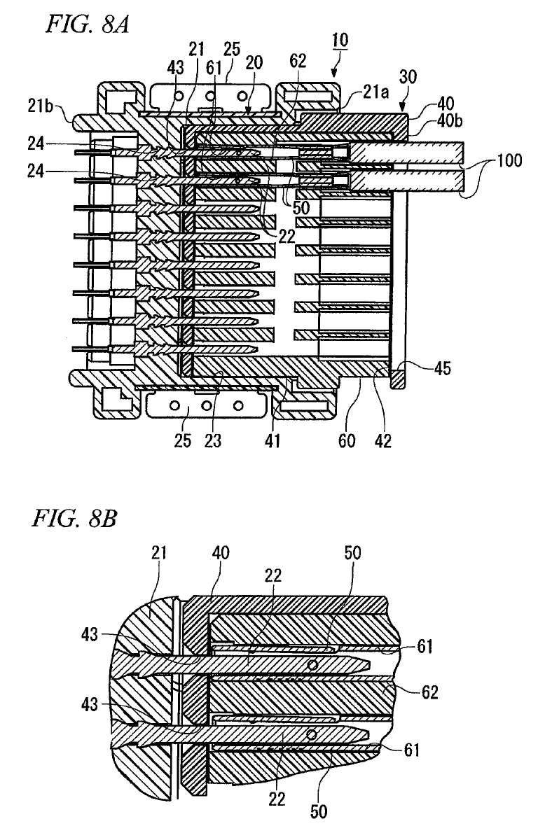

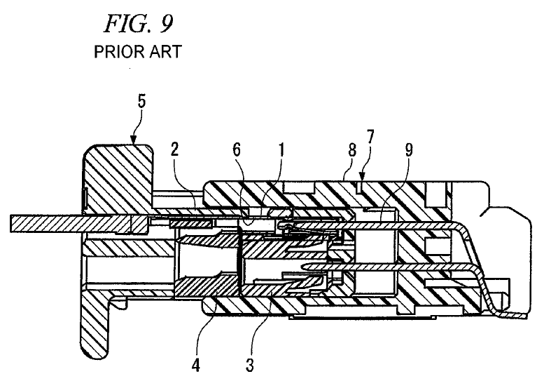

Next, as shown in FIG. 1, in the pre-latched state, the female contacts 50 installed to the end parts of the electric wires 100 are inserted into the contact receiving slots 61 in the retainer 60 through the opening 45 in the male housing 40, and the female contacts 50 are pre-latched by the lances 65 formed in the contact receiving slots 61 in the retainer 60. Thereafter, as shown in FIGS. 6A-6B, the retainer 60 is pushed in completely, and the convex locking member 63 is engaged with the second locking claw 46B, by which the latched state is formed. As shown in FIGS. 6A-6B and 8A-8B, the retainer 60 does not project from the side surface 41c of the convex part 41 of the male housing 40 and is located so as to be approximately flush with the side surface 41c or in an inner part of the convex part 41 beyond the side surface 41c. As shown in FIGS. 8A-8B, in this state, the contact slot 61 in the retainer 60 and the contact insertion opening 43 in the male housing 40 continue on one straight line. As a result, the female contact 50 held in the contact slot 61 faces to the contact insertion opening 43 in the male housing 40. Thereby, the male connector 30 is assembled.

The male connector 30, which has been assembled, mates with the female connector 20 that has been assembled separately. To mate the male connector 30 with the female connector 20, the convex part 41 of the male housing 40 is inserted into the mating recess 23 in the female housing 21. By doing this, the male contacts 22 of the female connector 20 are inserted into the female contacts 50 in the retainer 60 through the contact insertion openings 43 in the male housing 40. When the male housing 40 is inserted until the locking claw 41b of the convex part 41 engages with the locking concave part of the mating recess 23, the female housing 21 and the male housing 40 engage with each other, and the male contacts 22 and the female contacts 50 are electricity connected to each other.

In the state in which the retainer 60 is pre-latched to the retainer receiving slot 42, the retainer 60 projects from the side surface 41c of the convex part 41 of the male housing 40. In the pre-latched state, even if the worker makes an attempt to mistakenly mate the male connector 30 with the female connector 20, as shown in FIG. 1, the side surface 60a of the retainer 60 collides with the female housing 21 of the female connector 20, and the retainer 60 can not be pushed further into the mating recess 23. Therefore, the worker can surely get to know that the retainer 60 is in the pre-latched state. At this time, since the end part 42a of the retainer receiving slot 42 is formed in the vicinity of the tip end part 41d of the convex part 41, if the male connector 30 is inserted into the female connector 20, the side surface 60a of the retainer 60 immediately collides with the female housing 21. Therefore, the worker can early get to know that the retainer 60 is in the pre-latched state.

In the case where the worker makes an attempt to mistakenly mate the male connector 30 with the female connector 20 in the pre-latched state, the contact receiving slots 61 in the retainer 60 and the contact insertion openings 43 in the male housing 40 are misaligned with each other by the half pitch, and the partitions 62 of the retainer 60 are located so as to face toward the contact insertion openings 43. Therefore, the male contacts 22 collide with the partitions 62 through the contact insertion openings 43 and are not connected to the female contacts 50. Thereby, incomplete engagement of the male contacts 22 with the female contacts 50 can be prevented.

As described above, the configuration is made such that there is provided the retainer 60 that is inserted into the direction perpendicular to the insertion/removal direction of the male connector 30 with respect to the female connector 20, and further the retainer 60 can be locked at two stages of the pre-latched state and the latched state with respect to the male housing 40 by the first locking claw 46A and the second locking claw 46B. Thereby, the male contacts 22 and the female contacts 50 can reliably be connected electrically to each other. Also, when the retainer 60 is in the pre-latched state, wrong contact between the male contacts 22 and the female contacts 50 is prevented, and also if the worker makes an attempt to mate the male connector 30 with the female connector 20 mistakenly, the worker can early get to know this fact. Therefore, an inadvertent work loss can be avoided, and the work efficiency can be improved.

The foregoing illustrates some of the possibilities for practicing the invention. Many other embodiments are possible within the scope and spirit of the invention. For example, in the above-described embodiment, a detailed example of the electrical connector assembly 10 has been described. However, there is no intention of restricting the construction and shape of each part of the female connector 20 and the male connector 30, the number of poles of the male contacts 22 and the female contacts 50, and the like. It is, therefore, intended that the foregoing description be regarded as illustrative rather than limiting, and that the scope of the invention is given by the appended claims together with their full range of equivalents.

What is claimed is:

1. An electrical connector assembly, comprising:
a male connector including a male housing and a retainer;
the male housing being provided with a plurality of contact insertion openings and a retainer receiving slot; and
the retainer being provided with contact receiving slots corresponding to the contact insertion openings, the retainer being received in the retainer receiving slot in a direction perpendicular to a direction of extension of the contact insertion openings, the retainer being moveable between a pre-latched state where the contact insertion openings are misaligned from the contact receiving slots and a latched state where the contact insertion openings are aligned with the contact receiving slots.

2. The electrical connector assembly of claim 1, wherein the contact receiving slots are arranged in an arrangement pitch and the retainer projects from a side surface of the male housing by ½ of the arrangement pitch in the pre-latched state.

3. The electrical connector assembly of claim 1, wherein each of the contact receiving slots is provided with a female contact that is locked in the contact receiving slot by a lance.

4. The electrical connector assembly of claim 1, wherein the retainer is provided with partitions that separate each of the contact receiving slots, the partitions blocking the contact insertion openings in the pre-latched state.

5. The electrical connector assembly of claim 1, further comprising a female connector provided with a mating recess that receives the male housing, the retainer being received in the retainer receiving slot in a direction perpendicular to a direction in which the female connector receives the male housing.

6. The electrical connector assembly of claim 5, wherein the female connector is provided with a plurality of male contacts that are received in the contact insertion openings when the female connector and the male connector are mated.

7. The electrical connector assembly of claim 1, wherein the retainer includes a convex locking member that engages with a first locking claw of the male housing in the pre-latched state and a second locking claw of the male housing in the latched state.

8. The electrical connector assembly of claim 7, wherein the retainer includes a lock claw that engages with a locking claw of the male housing in at least the pre-latched state that prevents the retainer from falling out of the retainer receiving slot.
